(19) United States
(12) Patent Application Publication
(10) Pub. No.: US 2022/0334651 A1
(43) Pub. Date: Oct. 20, 2022

(54) KEYBOARD ILLUMINATION CONFIGURATION BASED ON KEY USAGE

(71) Applicant: Hewlett-Packard Development Company, L.P., Spring, TX (US)

(72) Inventors: Thomas da Silva Paula, Porto Alegre (BR); Alexandre Santos da Silva, Jr., Porto Alegre (BR); Wagston Tassoni Staehler, Porto Alegre (BR)

(73) Assignee: Hewlett-Packard Development Company, L.P., Spring, TX (US)

(21) Appl. No.: 17/641,161

(22) PCT Filed: Oct. 15, 2019
(86) PCT No.: PCT/US2019/056336

§ 371 Date: Mar. 8, 2022

(51) Int. Cl. G06F 3/02

(52) U.S. Cl. CPC G06F 3/0202

(57) ABSTRACT

A system may comprise a processor to execute an application, a keystroke analyzer module to determine a frequency with which each key on a keyboard is utilized during execution of the application, and a key illumination module to illuminate the keys on the keyboard with an illumination pattern that visually distinguishes a first subset of keys on the keyboard from a second subset of keys on the keyboard.

### BACKGROUND

Computing devices, such as desktop and laptop computers, may include a backlit keyboard. Some backlit keyboards allow for user customization. A user may customize an illumination pattern of the keyboard, such as the illumination color of keys on the keyboard. The user may prefer one illumination color for one application and another illumination color for another application.

### BRIEF DESCRIPTION OF THE DRAWINGS

Non-limiting and non-exhaustive examples of the disclosure are described with reference to the figures outlined below.

FIG. 1A illustrates an example of a keyboard of a computing system to implement various applications, such as a first person shooter (FPS) game.

FIG. 1B illustrates a table generated by a dynamic environment response (DER) system that includes a count of keys pressed during execution of the FPS game.

FIG. 1C depicts an example of a manual lighting configuration page for a keyboard of a computing device.

FIG. 1D illustrates an example of the DER system applying an illumination pattern to a keyboard generated during execution of the FPS game.

FIG. 2A illustrates an example of a computing system with a configurable backlit keyboard.

FIG. 2B illustrates a table generated by a DER system that includes a count of some of the keys pressed during execution of a multiplayer online battle arena (MOBA) game.

FIG. 2C illustrates an example of the DER system applying an illumination pattern to the keyboard of the computing system during execution of the MOBA game.

FIG. 3 illustrates an example of the DER system applying an illumination pattern to the keyboard remote during execution of the streaming service application.

FIG. 4 illustrates an example of a computing system with a DER system to analyze keystrokes and dynamically apply illumination patterns to each of a plurality of applications.

FIG. 5 illustrates a flowchart of an example of a method for a DER system to dynamically illuminate keys on a keyboard of a computing system based on the application currently being executed by the computing system.

### DETAILED DESCRIPTION

A user may utilize a computing system to execute word processing applications, spreadsheet applications, graphics editing applications, presentation development applications, e-mail messaging applications, web browsing applications, etc. A user may also utilize a computing system as an entertainment device to provide applications such as electronic games and audio/video material (e.g., movies and television programs).

The present disclosure generally relates to systems and methods for dynamically illuminating a keyboard with an illumination pattern based on tracked user interactions. For example, a dynamic environment response (DER) system may monitor a keyboard to determine how frequently each key on the keyboard is pressed during execution of an application by an underlying computing system. The DER system may then illuminate keys on the keyboard based on, for example, the frequency that each key is pressed.

For example, a user may use a computing device to execute an electronic game application. The electronic game may have a character set in a virtual world that the user navigates using a keyboard of the computing system. The keyboard may be integrated into the computing device (e.g., as part of a laptop device) or connected to the keyboard via a communication interface (e.g., wired or wireless). To advance the character through the game, the user may utilize (i.e., press) a first set of keys on the keyboard to move the character and a second set of keys on the keyboard to make the character interact in the virtual world.

Many of the keys on the keyboard may be rarely or never used during execution of the electronic game. The DER system may track the utilization of each key during execution of the electronic game. The DER system may create a table identifying the relative frequency with which each key is pressed and/or derive a heatmap of the keys pressed during execution of the electronic game. For instance, a heatmap of the keys pressed during execution of the electronic game may be generated to highlight the relative frequency with which each key is pressed. The DER system may generate a heatmap with frequently used keys shown brighter or in a different color than less frequently used keys and/or unused keys.

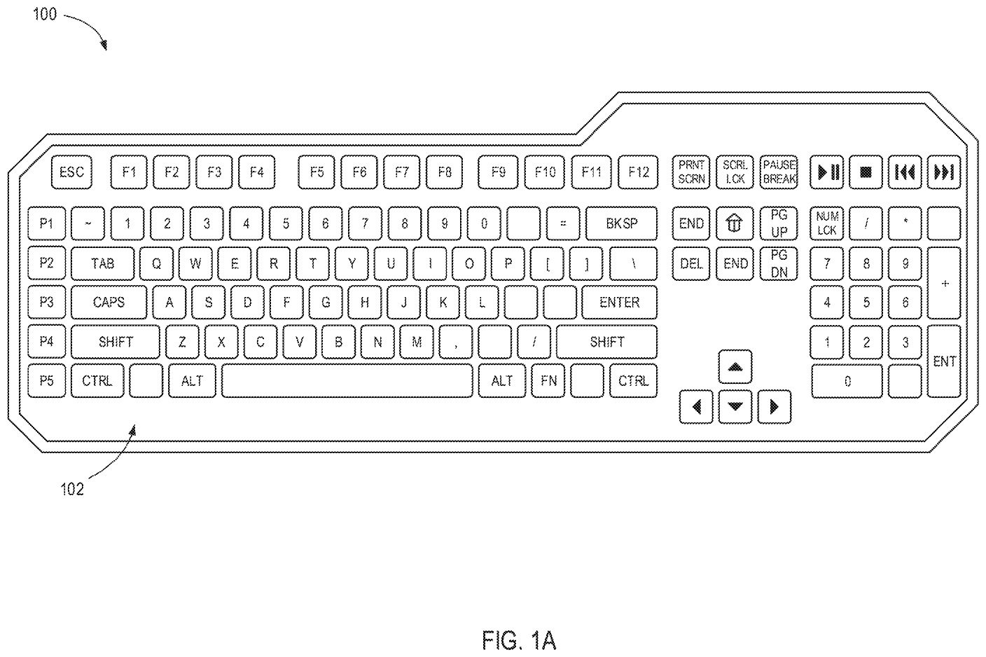

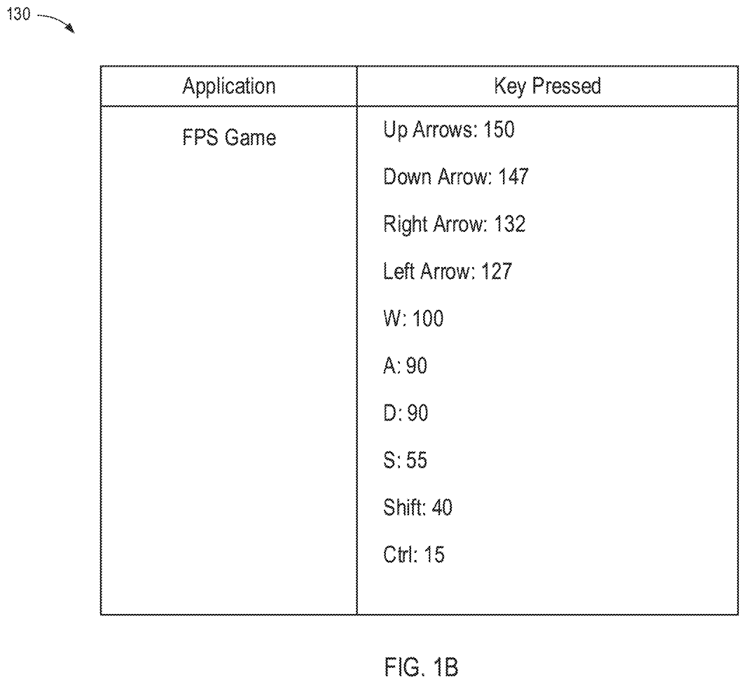

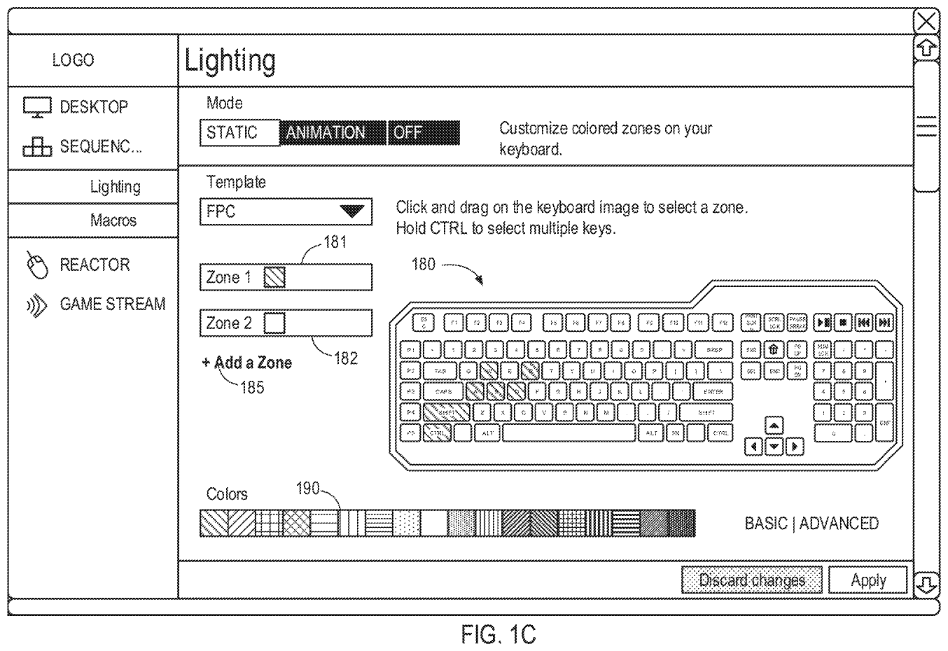

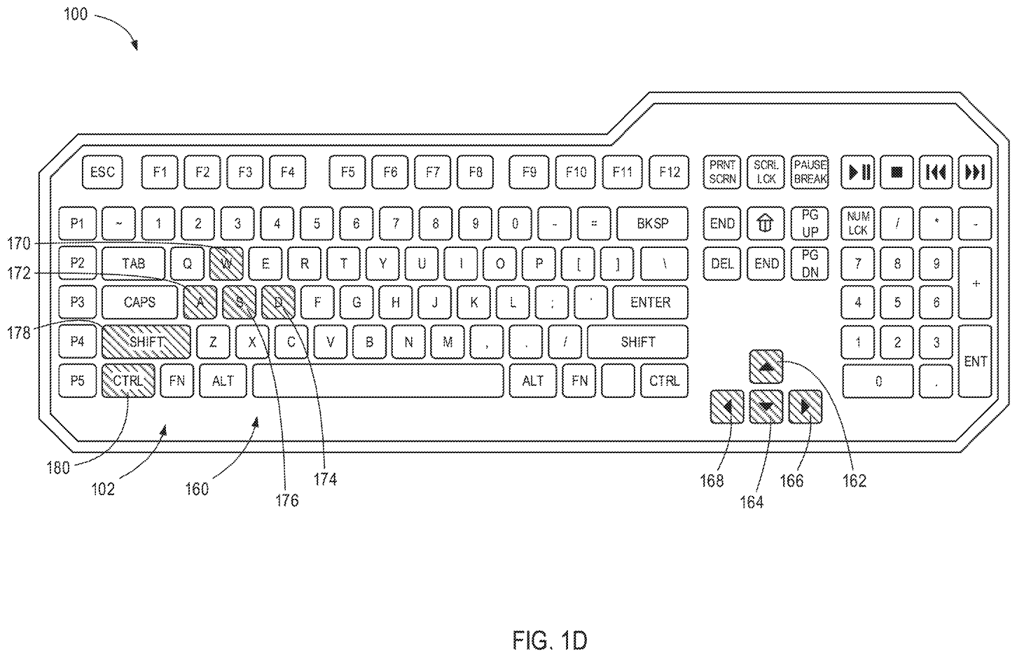

FIG. 1A illustrates an example top view of a keyboard 100 of a computing system to implement various applications. For example, the keyboard 100 may be used during the execution of a first-person combat (FPC) game, such as a first-person shooter (FPS) game. As shown, the keyboard 100 includes keys 102. In various examples, the keyboard 100 may include a backlight lighting system, such as a red, green, and blue (RGB) lighting system used to illuminate (e.g., backlight) the keys 102 with different colors and/or varying brightness.

FIG. 1B illustrates a table 130 generated by a DER system that includes a count of keys pressed during execution of the FPS game. In the illustrated example, the user pressed an up arrow key 150 times, a down arrow key 147 times, a right arrow key 132 times, a left arrow key 127 times, a W key 100 times, an A key 90 times, a D key 90 times, an S key 55 times, a shift key 40 times, and a Ctrl key 15 times. The other keys may be been used less frequently and/or not used at all.

Keys used below a threshold level and/or significantly less than other keys in the table may be omitted from the table. The DER system may develop a heatmap of the keys based on usage. In one example, the keys pressed 15 or more times (all the keys listed in the table 130) may be shown on the heatmap in a first color while the other keys may be illuminated with a second color. The heatmap can be implemented as an illumination pattern during subsequent or continued execution of the FPS game.

FIG. 1C depicts a virtual heatmap 180 of the keys used more frequently as part of Zone 1 181 in a first color. The keys used less frequently are shown as part of Zone 2 182 in a different color. The DER system may automatically assign colors 190 to the zones and/or may automatically assign keys to the different zones. In some example, the DER system may utilize more than two zones (e.g., via “+ Add a Zone” 185) with the keys divided among the various zones according to the frequency with which they are used. In one example, each key may be mapped to a specific color based on the frequency with which it is used. For example, keys that are not used or rarely used during execution of the FPS game may be mapped to white. The less frequently used keys may be mapped to blue and the most frequently used keys may be mapped to red. Other keys may be mapped to wavelengths between blue and red based on the frequency with which they are used during execution of the FPS game.

In yet another example, the DER system may monitor the utilization frequency of the keys on the keyboard and classify some keys as “frequently used” and other keys as “infrequently used” based on a relative grouping or threshold level. To distinguish the frequently used keys from the infrequently used keys, the DER system may illuminate the frequently used keys with one color and not illuminate the infrequently used keys or illuminate the infrequently used keys with a different color.

FIG. 1D illustrates an example of the keyboard 100 with an illumination pattern 160 applied to some of the keys based on the key utilization heatmap (180, FIG. 1C). As described herein, the heatmap of key utilization is based on the frequency with which each key on the keyboard is utilized during execution of the application. In the illustrated example, the illumination pattern 160 includes illumination of the up arrow key 162, the down arrow key 164, the right arrow key 166, and the left arrow key 168. The illumination pattern 160 further includes illumination of the W key 170, the A key 172, the D key 174, the S key 176, the left shift key 178, and the Ctrl key 180. In the illustrated example, the DER system does not illuminate the other keys. In alternative examples, the other keys may be illuminated with a different color(s) and/or illuminated with white light.

In some examples, the arrow keys 162, 164, 166, and 168 may be illuminated with a first color or brightness and the other illuminated keys 170-180 may be illuminated with a second color or brightness. The remaining keys may be illuminated with a third color or brightness, or not be illuminated at all. In some examples, when the computing system ceases execution of the FPS game, the DER system may revert the illumination pattern 160 to a default illumination pattern. The default illumination pattern may, for example, be an all-white illumination pattern, a single-color illumination pattern, and/or a user-defined illumination pattern. The DER system may detect subsequent execution of the FPS game and apply the previously determined illumination pattern 160 based on previously tracked key usage. As described below, the DER system may also detect execution of different applications and apply different illumination patterns based on the different key usage associated with each different application.

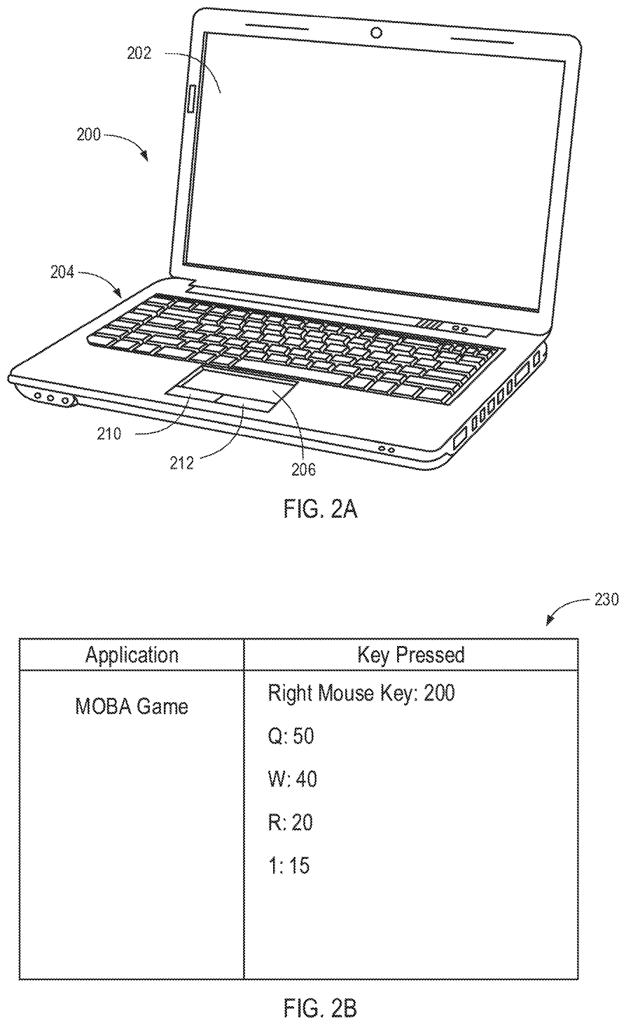

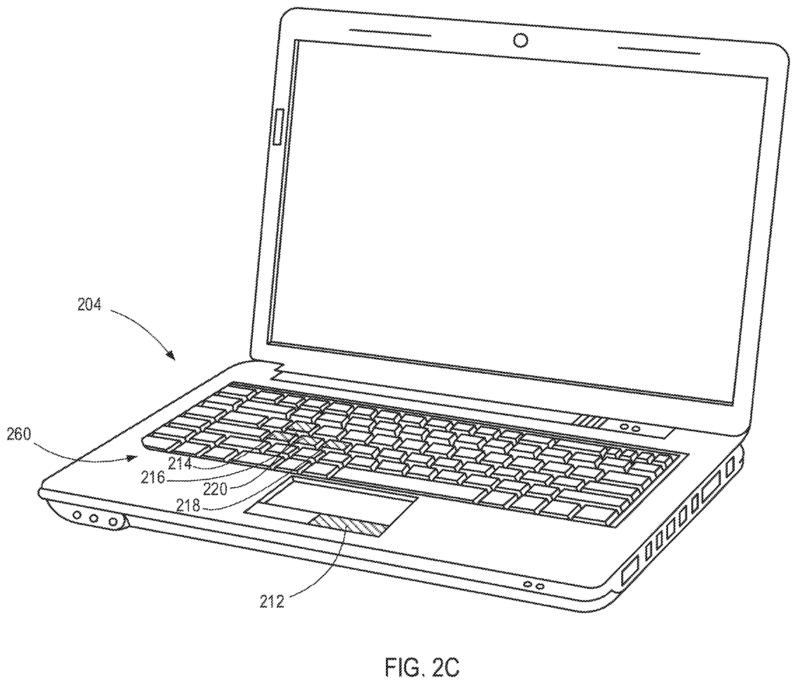

FIG. 2A illustrates an example of a laptop computing system 200 with an integrated keyboard 204 and an integrated electronic display 202. The keyboard 204 may include a plurality of keys and a backlight system to illuminate the keys with a configurable illumination pattern. In some examples, a trackpad 206 may include left 210 and right 212 mouse buttons.

FIG. 2B illustrates a table 230 generated by a DER system that includes a count of some of the keys pressed during execution of a multiplayer online battle arena (MOBA) game. As illustrated, the DER system detected that a right mouse key was pressed 200 times, a Q key was pressed 50 times, a W key was pressed 40 times, an R key was pressed 20 times, and a 1 key was pressed 15 times. Notably, the keys pressed with high frequency during execution of the MOBA game are different than the keys pressed with high frequency during execution of the FPS game described in conjunction with FIGS. 1A-1D. Accordingly, the DER system may determine a first heatmap and/or illumination pattern for the FPS game (as illustrated in FIG. 1D) and a second heatmap and/or illumination pattern for the MOBA game.

FIG. 2C illustrates an example of the DER system applying an illumination pattern 260 to the keyboard 204 of the computing system 200 during execution of the MOBA game. The illumination pattern 260 for the MOBA game may include illumination of the A key 214, the S key 216, the D key 218, and the W key 220. In some examples, the right trackpad mouse key 212 may also be illuminated if trackpad illumination is also available. The other keys on the keyboard 204 may not be illuminated at all, illuminated white, or illuminated with another color

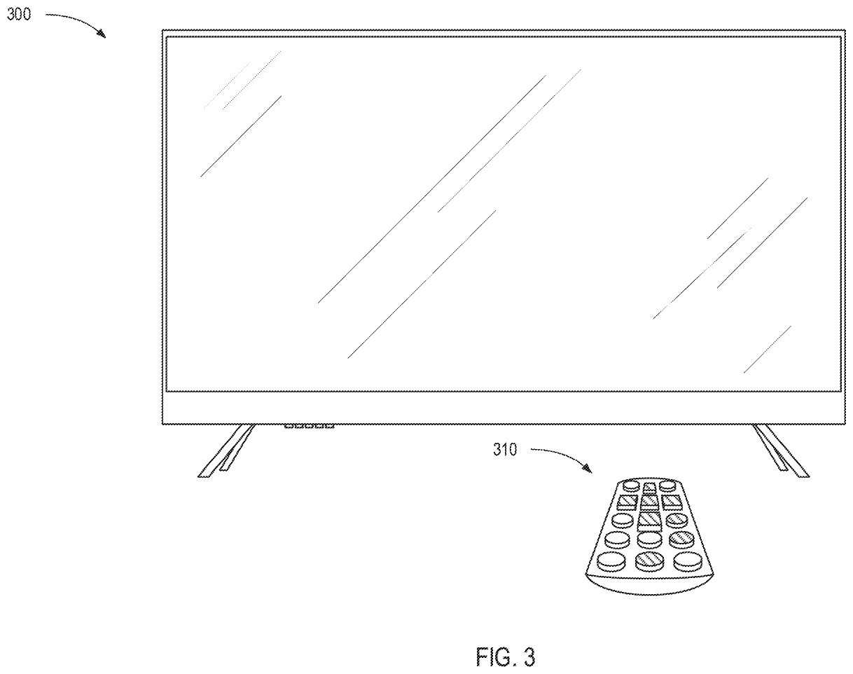

FIG. 3 illustrates an example of a DER system illuminating keys (the shaded keys) on a remote keyboard 310 used in conjunction with a computing system displaying streaming content on a television 300. The DER system may be integrated into the remote keyboard 310 as hardware, firmware, computer-executable instructions, and/or a combination thereof. The DER system may track the frequency with which each of the buttons on the remote keyboard 310 is used with a particular streaming content application. Those keys that are used most frequently may be illuminated on the remote keyboard with an illumination pattern to distinguish them from less frequently used keys.

The computing system displaying the streaming content may indicate to the DER system that a second streaming content application is being utilized and the DER system may respond by illuminating a different combination of buttons based on tracked key utilization data for the second streaming content application.

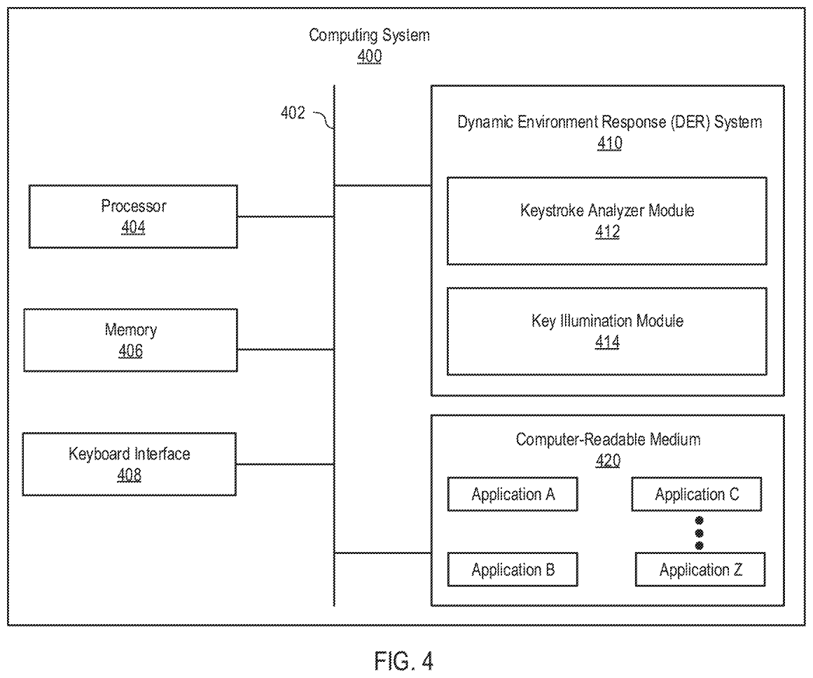

FIG. 4 illustrates an example of a computing system 400 to apply an illumination pattern to keys on a keyboard based on the application being executed. The computing system 400 may include a bus 402 connecting a processor 404 (e.g., microprocessor, Field Programmable Gate Array (FPGA), microcontroller, etc.), a memory 406, a keyboard interface 408, a computer-readable storage medium 420 with a plurality of selectively-executable applications (e.g., Applications A-Z), and a DER system 410. The keyboard interface 408 may connect the computing system 400 to an integrated keyboard, such as in a laptop computing device, or to an external keyboard (e.g., a wired or wireless external keyboard).

The DER system 410 may be implemented as hardware, firmware, and/or instructions to be executed by the processor 404 (e.g., instructions stored on a non-transitory computer-readable medium). The DER system 410 may include a keystroke analyzer module 412 and a key illumination module 414. Each of the keystroke analyzer module 412 and the key illumination module 414 may be implemented as hardware components, firmware components, computer-executable instructions, and/or a combination thereof.

The keystroke analyzer module 412 may determine a frequency with which each key on a keyboard is utilized during execution of a first application. In some instances, the keystroke analyzer module 412 may be integrated with or be in communication with a USB driver or keyboard-specific driver of the keyboard used with the computing system. In other examples, the keystroke analyzer module 412 may be comprise sensors in the keyboard itself to detect key presses during execution of an application. The keystroke analyzer module 412 may alternatively operate at the operating system (OS) level to collect key press information provided by the OS during execution of the application by the computing system.

The keystroke analyzer module 412 may determine the frequency with which each key on the keyboard is utilized during execution of the first application only when the first application is the active application. Keystrokes made while the first application is inactive may be ignored for the purposes of determine the frequency with which each key on the keyboard is utilized. For example, an OS of the computing device may facilitate the execution of multiple applications at the same time. However, only one of the applications is considered “active” at any given time. User inputs provided by the keyboard only affect the active application and not concurrently executed “inactive” applications. Accordingly, the keystroke analyzer module 412 may associate keystrokes with the active application and not inactive applications.

The key illumination module 414 may illuminate the keys on the keyboard with a first illumination pattern that visually distinguishes a first subset of keys on the keyboard from a second subset of keys on the keyboard based on utilization frequency during execution of the first application. The keystroke analyzer module 412 may generate heatmaps of key utilization on the keyboard during execution of each of the Applications A-Z in the computer-readable medium 420. The DER system 410 may detect execution of each different application. The key illumination module 414 may illuminate the keys on the keyboard based on the respective heatmaps of key utilization generated for each of the different applications by the keystroke analyzer module 512.

As described herein, the DER system 410 may divide the set of keys on the keyboard into two subsets of keys. A first subset of keys may include those keys used above a threshold frequency during execution of a first application. A second subset of keys may include those keys used below the threshold frequency during execution of the second application. The threshold frequency may be defined as a fixed number or as a relative value grouping frequently used keys separate from less frequently used keys.

The key illumination module 414 may illuminate the first subset of keys on the keyboard with the first illumination pattern in which each key in the first subset of keys is illuminated with a first color to visually distinguish the first subset of keys from the second subset of keys. In some examples, the second subset of keys may be illuminated with a second color.

In other examples, each subset of keys may be illuminated with the same color but with different intensities. In still other examples, each key may be illuminated with a wavelength corresponding to a key-specific utilization frequency. In such an example, each key may be illuminated a different color based on utilization frequency. In other examples, the keys may be divided into N number of subsets, where N is an integer value and each of the N subsets may be illuminated a different color.

The keystroke analyzer module 412 may determine a frequency with which each key on the keyboard is utilized during execution of a second application, a third application, a fourth application, etc. The key illumination module 414 may illuminate the keys according to a unique illumination pattern depending on which application (e.g., Application A-Z) is currently being executed by the computing system 400.

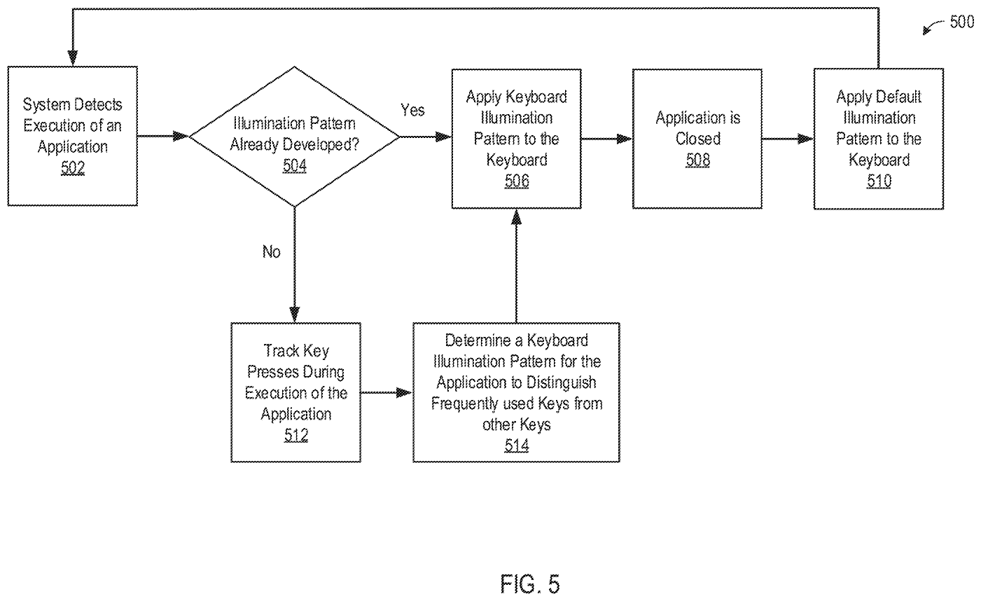

FIG. 5 illustrates a flowchart 500 of an example of a method for a DER system to dynamically illuminate keys on a keyboard of a computing system based on the application currently being executed by the computing system. As illustrated, the DER system may detect, at 502, the execution of an application by the computing system. If an illumination pattern has already been developed, at 504, for the application, the DER system may apply, at 506, the keyboard illumination pattern to the keyboard. Once the application is closed, at 508, the DER system may apply, at 510, a default illumination pattern to the keyboard until execution of another application is detected, at 502.

If an illumination pattern has not already been developed, at 504, then a keystroke analyzer of the DER system may track, at 512, key presses during execution of the application. The DER system may determine (e.g., develop, calculate, or create), at 514, a keyboard illumination pattern for the application that distinguishes frequently used keys from other keys. The key illumination module of the DER system may then apply, at 506, the keyboard illumination pattern to the keyboard until the application is closed, at 508, and the default illumination pattern is applied to the keyboard, at 510, and/or the DER system detects that another application is being executed by the computing system, at 502.

While specific examples and applications of the disclosure have been illustrated and described, it is understood that the disclosure is not limited to the precise configurations and components disclosed herein. Accordingly, many changes may be made to the details of the above-described examples without departing from the underlying principles of this disclosure consistent with the following claims.

1. A system comprising:
a processor to execute a first application;
a keystroke analyzer module to determine a frequency with which each key on a keyboard is utilized during execution of the first application; and
a key illumination module to illuminate the keys on the keyboard with a first illumination pattern that visually distinguishes a first subset of keys on the keyboard from a second subset of keys on the keyboard based on utilization frequency during execution of the first application.

2. The system of claim 1, wherein the first illumination pattern comprises an illumination pattern in which each key in the first subset of keys is illuminated with a first color and each key in the second subset of keys is illuminated with a color other than the first color.

3. The system of claim 1, wherein the first illumination pattern comprises an illumination pattern in which a brightness of each illuminated key is based on the utilization frequency.

4. The system of claim 1, wherein the first illumination pattern comprises an illumination pattern in which each key is illuminated at a wavelength corresponding to the utilization frequency of each respective key.

5. The system of claim 1, wherein the processor is further to execute a second application,
wherein the keystroke analyzer module is further to determine a frequency with which each key on the keyboard is utilized during execution of the second application, and
wherein the key illumination module is further to illuminate the keys on the keyboard with a second illumination pattern that visually distinguishes a third subset of keys on the keyboard relative to a fourth subset of keys on the keyboard based on utilization frequency during subsequent execution of the second application.

6. The system of claim 1, wherein the key illumination module and the keystroke analyzer module comprise electronic control circuitry to operate concurrent with the execution of the first application by the processor.

7. The system of claim 1, wherein the key illumination module and the keystroke analyzer module comprise computer-executable instructions for execution by the processor.

8. A system comprising:
a processor to execute a first application and a second application;
a keystroke analyzer module to
generate a first heatmap of key utilization on a keyboard based on a frequency with which each key on the keyboard is utilized during execution of the first application, and
generate a second heatmap of key utilization on the keyboard based on a frequency with which each key on the keyboard is utilized during execution of the second application; and
a key illumination module to
illuminate the keys on the keyboard based on the first heatmap during execution of the first application to visually distinguish a first subset of keys used more frequently than a second subset of keys during execution of the first application, and
illuminate the keys on the keyboard based on the second heatmap during execution of the second application to visually distinguish a third subset of keys used more frequently than a fourth subset of keys during execution of the second application.

9. The system of claim 8, wherein the first illumination pattern comprises an illumination pattern in which each key is illuminated at a wavelength corresponding to the first heatmap of key utilization.

10. The system of claim 8, wherein the second illumination pattern comprises an illumination pattern in which each key is illuminated at a wavelength corresponding to the second heatmap of key utilization.

12. A non-transitory computer-readable medium with instructions stored thereon that, when implemented by a processor, cause the processor to:
execute, via the processor, a first application;
determine, via a keystroke analyzer module, a frequency with which each key on a keyboard is utilized during execution of the first application; and
illuminate, via a key illumination module, the keys on the keyboard with a first illumination pattern that visually distinguishes a first subset of keys on the keyboard from a second subset of keys on the keyboard based on utilization frequency during execution of the first application.

13. The non-transitory computer-readable medium of claim 12, wherein the first illumination pattern comprises an illumination pattern in which each key in the first subset of keys is illuminated with a first color and each key in the second subset of keys is illuminated with a color other than the first color.

14. The non-transitory computer-readable medium of claim 12, wherein the first illumination pattern comprises an illumination pattern in which each key in the first subset of keys is illuminated with a brightness exceeding that of the keys in the second subset of keys.

15. The non-transitory computer-readable medium of claim 12, wherein the first illumination pattern is based on a heatmap of key utilization on a keyboard based on a frequency with which each key on the keyboard is utilized during execution of the first application.
